(19) United States
(12) Patent Application Publication
(10) Pub. No.: US 2026/0339610 A1
(43) Pub. Date: Oct. 29, 2026

(54) Integrated Circuit and Method for In-Pipeline Loop-Multiplier Scaling in GPU and ASIC Tensor- Core Fused Multiply-Add Units

(71) Applicant: Jonathan Washburn, Austin, TX (US)

(72) Inventor: Jonathan Washburn, Austin, TX (US)

(21) Appl. No.: 19/654,822

(22) Filed: Apr. 22, 2026

Related U.S. Application Data
(60) Provisional application No. 63/794,473, filed on Apr. 25, 2025.

(51) Int. Cl. G06F 7/544; G06F 5/01; G06F 7/50; G06F 7/523

(52) U.S. Cl. CPC G06F 7/5443; G06F 5/01; G06F 7/50; G06F 7/523

(57) ABSTRACT

An integrated circuit and method are disclosed for in-pipeline scaling within a fused multiply-add execution path. A protected internal factor source provides a scaling factor to an in-pipeline scaling stage that applies the factor to a selected multiplicand within a fused multiply-add pipeline under control logic configured to invoke a corrected fused multiply-add operation. A fused multiply-add core then generates a corrected result using the scaled multiplicand. In preferred embodiments, the scaling occurs at a fixed point in the pipeline, without a separate software-visible scaling multiply instruction, and the corrected result is produced through a single architectural rounding path. In more particular embodiments, the scaling factor is equal to (1−delta_loop), where delta_loop=X_opt\hat{ }(1+R_RP), X_opt=phi/pi, and R_RP=7/12.

### CROSS-REFERENCE TO RELATED APPLICATIONS

This application claims the benefit of U.S. Provisional Patent Application No. 63/794,473, filed on Apr. 25, 2025, and titled “Loop-Multiplier Microcode for GPU and ASIC Tensor-Core FMA Units,” the entirety of which is incorporated herein by reference.

### BACKGROUND

The present disclosure relates generally to semiconductor accelerator design and, more particularly, to fused multiply-add execution hardware, tensor-core datapaths, micro-op controlled arithmetic pipelines, and hardware handling of correction-factor scaling for floating-point and related numeric operations.

Modern GPUs, AI accelerators, and scientific-computing ASICs execute very large numbers of fused multiply-add operations in tensor-core and related arithmetic units. In many workloads, including physics, simulation, and numerically sensitive compute pipelines, a multiplicative correction factor must be applied to one operand associated with a multiply-add operation.

In existing implementations, such correction-factor application is commonly performed using a separate software-visible multiply instruction before or in conjunction with the fused multiply-add operation. This approach can consume an additional instruction issue opportunity, an additional constant or register fetch, and an additional arithmetic step in the execution sequence.

Where the correction is applied outside the fused multiply-add datapath, the execution path may also introduce an additional rounding event prior to final result generation. In floating-point arithmetic, the number and order of rounding events can affect the resulting bit pattern, particularly in numerically sensitive kernels, reductions, and repeated large-scale computations.

Software-side correction-factor application can also increase implementation variability across compilers, toolchains, architectures, and scheduling behaviors. Different instruction ordering, fusion behavior, register allocation, or execution ordering may produce non-identical low-order results even where the same nominal mathematical operation is intended.

In addition, when a correction factor is handled through software-visible mechanisms, the factor may be stored, loaded, substituted, transformed, or otherwise processed outside the arithmetic pipeline in ways that complicate reproducibility, control, validation, or implementation consistency.

Existing compute architectures therefore present practical difficulties for workloads in which a correction factor is repeatedly associated with fused multiply-add execution and where latency, energy, instruction count, rounding behavior, and reproducibility are significant considerations. Accordingly, a need exists for improved execution architectures for applying correction-factor scaling in connection with fused multiply-add operations in GPU, ASIC, tensor-core, and related arithmetic hardware.

### SUMMARY

In one aspect, the present disclosure provides an integrated circuit execution architecture in which a correction factor is applied to an operand within a fused multiply-add pipeline under internal control so that a corrected multiply-add operation is executed in the arithmetic pipeline rather than through a separate software-visible scaling multiply.

In certain embodiments, the integrated circuit includes a tensor-core or related fused multiply-add execution unit, a protected internal source of a scaling factor, a control path configured to invoke a scaled fused multiply-add operation, a pre-multiply datapath stage configured to apply the scaling factor to a selected multiplicand within the fused multiply-add pipeline, and a fused multiply-add unit configured to generate a result using the scaled multiplicand.

In certain embodiments, the scaled fused multiply-add operation is executed such that the scaling action is performed at a fixed location within the execution pipeline. In preferred embodiments, the scaling action is absorbed into an existing pipeline stage so that the scaled fused multiply-add operation is executed with no additional clock cycles relative to a corresponding unscaled fused multiply-add operation.

In certain embodiments, the corrected operation is represented as:

result=(A×(1−delta_loop))×B+C

In certain embodiments, delta_loop is defined as:

delta_loop=X_opt\hat{ }(1+R_RP) where X_opt=phi/pi and R_RP=7/12.

In certain embodiments, the scaling factor corresponding to (1−delta_loop) is derived from a protected stored value of delta_loop and loaded into one or more non-user-accessible internal scaling registers used by the fused multiply-add datapath.

In preferred embodiments, the scaled operand is generated within the fused multiply-add pipeline without an intermediate architectural rounding step before completion of the fused multiply-add operation. In preferred embodiments, the result is produced through a single architectural rounding path.

In certain embodiments, the protected stored value is provisioned in one-time-programmable memory and loaded during device initialization, reset, boot, or other startup sequencing. In other embodiments, the protected stored value is provided through another non-user-modifiable or privileged internal storage mechanism.

In certain embodiments, the scaled fused multiply-add operation is invoked by a dedicated micro-op, opcode, instruction encoding, decode state, or control tag recognized by an instruction decoder and scheduled through an existing tensor-core or arithmetic execution scheduler.

In certain embodiments, the disclosed architecture reduces or eliminates a separate software scaling multiply, reduces instruction-path overhead associated with external correction-factor handling, reduces additional rounding-path variability, and improves deterministic execution behavior for workloads using repeated correction-factor scaling.

In certain embodiments, the present disclosure further provides methods of executing corrected fused multiply-add operations, integrated circuits implementing such corrected fused multiply-add operations, non-transitory computer-readable media storing instructions that invoke such corrected fused multiply-add operations, and downstream implementations in scientific, simulation, and AI compute environments.

Additional embodiments, features, and advantages will be apparent from the following description, drawings, and claims.

### BRIEF DESCRIPTION OF THE DRAWINGS

FIG. 1 is a high-level block diagram of an accelerator subsystem including a tensor-core execution path having protected factor storage, decode and scheduler control, an in-pipeline scaling path, and a fused multiply-add execution unit.

FIG. 2 is a comparative pipeline diagram showing a standard fused multiply-add execution path and a scaled fused multiply-add execution path in which scaling is performed within the pipeline.

FIG. 3 is a hardware flow diagram showing loading of a stored correction value, derivation of a scaling factor, decode of a scaled fused multiply-add operation, in-pipeline operand scaling, fused multiply-add execution, and writeback of a result.

FIG. 4 is a block diagram of protected factor storage, provisioning, initialization loading, and optional verification logic for supplying an internal scaling factor to the fused multiply-add pipeline.

FIG. 5 is a control-path diagram showing decode, scheduling, operand routing, and optional operand-selection logic for invoking in-pipeline scaling of a selected multiplicand.

FIG. 6 is a numerical-behavior diagram showing an extended-precision pre-multiply path and a single-rounding fused multiply-add result path relative to a software path having an intermediate rounded value.

FIG. 7 is a format-support and reproducibility diagram showing representative supported numeric formats and representative validation behavior across process, voltage, and temperature conditions.

FIG. 8 is a platform-variant diagram showing representative GPU, ASIC, systolic-array, chiplet, integer-core, and mobile-system embodiments of the disclosed architecture.

FIG. 9 is a toolchain and implementation-flow diagram showing source-level invocation, compiler or backend emission of a scaled fused multiply-add operation, RTL implementation, verification, and deployment.

FIG. 10 is a downstream-application diagram showing representative uses of the disclosed scaled fused multiply-add architecture in scientific, simulation, and AI workloads.

FIG. 11 is a manufacturing and provisioning diagram showing representative preparation, programming, loading, and deployment of a protected stored correction value.

FIG. 12 is a validation-flow diagram showing representative formal-verification, timing-validation, energy-validation, reproducibility-validation, and acceptance-flow processes for the disclosed architecture.

### DETAILED DESCRIPTION

The following description sets forth representative embodiments of integrated circuits, execution architectures, control logic, storage structures, arithmetic paths, and related methods for performing in-pipeline correction-factor scaling in connection with fused multiply-add operations. The disclosure is directed to a specific arithmetic-pipeline architecture and should not be understood as being limited to only the exact embodiments expressly illustrated, except as may be required by the claims.

In the disclosed architecture, a correction factor is supplied to a fused multiply-add execution path in a manner that allows a selected operand to be scaled within the fused multiply-add pipeline itself. In preferred embodiments, the scaling is performed under micro-op or decode control, and the scaled operand is then consumed by a fused multiply-add unit that generates the final result.

In contrast to approaches in which a correction factor is applied through a separate software-visible multiply instruction, the disclosed architecture performs correction-factor application in the arithmetic pipeline. As a result, the corrected operation may be issued and executed as a specialized fused multiply-add path rather than as a sequence requiring an externally visible multiply followed by a separate fused multiply-add.

In certain embodiments, the corrected fused multiply-add operation is represented as:

result=(A×S)×B+C

where A, B, and C are arithmetic operands and S is an internally supplied scaling factor.

In more particular embodiments disclosed herein, the scaling factor S is equal to (1−delta_loop), and the corrected operation is represented as:

result=(A×(1−delta_loop))×B+C

In certain disclosed embodiments, delta_loop is defined as:

delta_loop=X_opt\hat{ }(1+R_RP) where X_opt=phi/pi and R_RP=7/12.

In certain embodiments, delta_loop is stored directly in protected internal storage, and the scaling factor (1−delta_loop) is derived therefrom during initialization or runtime preparation. In other embodiments, the scaling factor itself may be stored directly, or both delta_loop and (1−delta_loop) may be stored in different forms or formats.

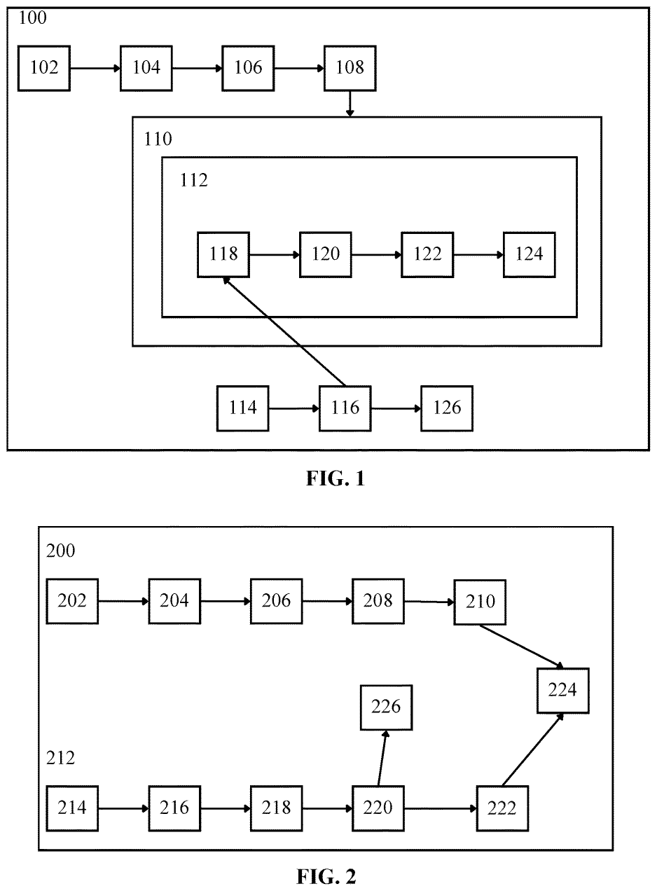

Referring generally to FIG. 1, an accelerator subsystem 100 may include an instruction source 102 that provides an instruction stream 104 to an instruction decoder 106. The instruction decoder 106 may cooperate with a scheduler 108 to issue arithmetic operations to a tensor-core cluster 110 including one or more tensor cores 112.

In certain embodiments, the accelerator subsystem 100 further includes a protected factor store 114 and one or more scaling registers 116. The protected factor store 114 may contain, directly or indirectly, a value from which the scaling factor is obtained. The scaling registers 116 may store one or more internal representations of the scaling factor for use by arithmetic datapaths.

In certain embodiments, the tensor core 112 includes a pre-multiply stage 118, a fused multiply-add unit 120, and a writeback path 122 that delivers results to a result buffer 124 or other storage destination. In some embodiments, the subsystem further includes a diagnostic interface 126, which may provide limited verification information regarding the protected stored value or a derivative thereof.

In certain embodiments, the instruction decoder 106 recognizes a dedicated scaled fused multiply-add operation. The decoder may identify such an operation using an opcode, micro-op tag, encoded control state, or other instruction representation associated with in-pipeline operand scaling.

In response to recognition of the scaled fused multiply-add operation, the scheduler 108 may issue the operation to the tensor core 112 and assert one or more control signals causing the pre-multiply stage 118 to apply the scaling factor to a selected multiplicand. In preferred embodiments, the selected multiplicand is operand A. In alternative embodiments, operand B may be selected, or both multiplicands may be scaled in sequence or in parallel, depending on the particular hardware design.

Referring generally to FIG. 2, a standard fused multiply-add path 200 may include a fetch stage 202, an align stage 204, a multiply stage 206, and an add-and-round stage 208 that yields a standard result 210. A scaled fused multiply-add path 212 may include a fetch stage 214, an align-and-scale stage 216, a multiply stage 218, and an add-and-round stage 220 that yields a scaled result 222. In certain embodiments, a latency-equivalence indicator 224 represents that the scaled fused multiply-add path 212 is configured to execute with the same number of clock cycles as the standard fused multiply-add path 200 in a preferred implementation. In certain embodiments, a single-rounding indicator 226 represents that the scaled fused multiply-add path 212 produces its result through a single architectural rounding path, in contrast to a software-side scaling sequence that introduces an intermediate rounded value before fused multiply-add completion.

In preferred embodiments, the align-and-scale stage 216 reuses arithmetic or timing capacity available in an existing stage so that the scaled fused multiply-add path 212 operates with the same number of clock cycles as the standard fused multiply-add path 200. In such embodiments, the disclosed scaling action adds zero additional clock cycles relative to the standard fused multiply-add pipeline.

In certain embodiments, this unchanged-latency execution is achieved by performing the pre-multiply scaling in a stage that would otherwise perform alignment, operand preparation, normalization, or another pre-multiply datapath function. In some embodiments, a dedicated DSP slice, arithmetic lane, or local multiplier resource is used in that stage. In other embodiments, equivalent arithmetic resources may be used.

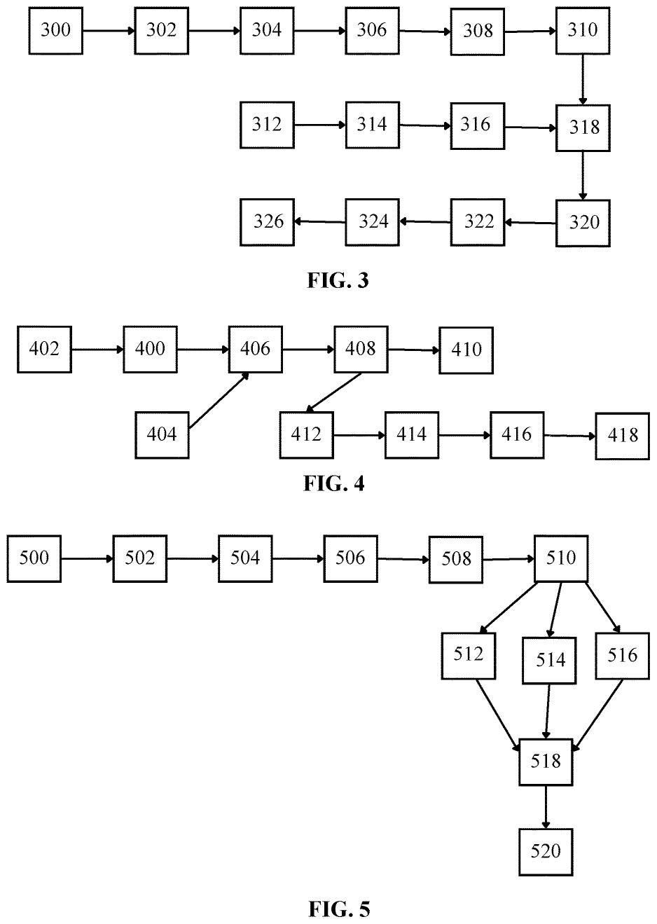

Referring generally to FIG. 3, a reset event 300 may initiate loading of stored correction information from an OTP fuse array 302 through load logic 304 into a delta register 306. Factor-derivation logic 308 may compute or otherwise prepare one or more scale-factor values, which may be placed into a scaling register bank 310.

In certain embodiments, the scaling register bank 310 stores one or more numeric representations of the scaling factor, including fixed-point and floating-point representations suitable for the datapaths with which the tensor core operates. In representative embodiments, formats corresponding to FP16, BF16, TF32, FP32, and FP64 may be prepared and stored.

In certain embodiments, a scaled fused multiply-add instruction is received at an opcode decode block 312. In response, the opcode decode block 312 causes assertion of a scale control bit 314 or equivalent control signal.

In certain embodiments, the scale control bit 314 enables scaling of an operand A path 316 by a pre-multiply arithmetic block 318 using the scaling factor from the scaling register bank 310. The pre-multiply arithmetic block 318 yields a scaled operand output 320 that is then provided to a fused multiply-add execution block 322. A writeback stage 324 generates a rounded result 326.

In preferred embodiments, the rounded result 326 is generated without an intermediate architectural rounding step between the pre-multiply arithmetic block 318 and the fused multiply-add execution block 322. In such embodiments, the disclosed path provides a single-rounding output behavior.

Referring generally to FIG. 4, protected factor storage may be provided in OTP memory 400. In certain embodiments, the OTP memory 400 is programmed through a wafer-sort programming interface 402. In some embodiments, an optional authentication block 404 may be used to authenticate a fuse image, provisioning image, or other initialization data prior to or in connection with device provisioning.

In certain embodiments, a reset loader 406 transfers a stored value into a non-user-accessible scaling register 408. A software isolation boundary 410 may prevent ordinary application software or user-mode code from directly reading or writing the stored value or scaling register contents.

In certain embodiments, a hash generator 412 and a diagnostic instruction path 414 may produce a hash output 416 or other verification output suitable for communication to an external verifier 418.

In preferred embodiments, the diagnostic path provides verification information without exposing the raw protected value.

OTP storage is preferred in certain embodiments because it can provide a non-user-modifiable internal source of the correction value or scaling factor. However, OTP is not required in all embodiments. In alternative embodiments, protected internal storage may be provided by privileged firmware-loaded registers, secure enclaves, one-time initialization structures, mask-programmed storage, nonvolatile internal memory, or other internal storage architectures that preserve the intended control and non-user accessibility characteristics.

Referring generally to FIG. 5, a control path may receive an instruction packet 500 including an opcode field 502. A decoder 504 may identify a scaled fused multiply-add operation and cooperate with a scheduler 506 and operand-placement logic 508.

In certain embodiments, a scale-select field 510 or equivalent control may drive an A-path selector 512, a B-path selector 514, or a dual-scale optional selector 516, thereby permitting the architecture to scale operand A, operand B, or both multiplicands. An issued micro-op 520 may be sent to an issue port 518 or equivalent execution interface.

In preferred embodiments, operand A is the scaled multiplicand. This arrangement may be advantageous where the compiler, microcode generator, or scheduler places a correction-bearing or constant-bearing multiplicand in the first multiplicand position. However, the invention is not limited to operand A selection unless expressly recited in a claim.

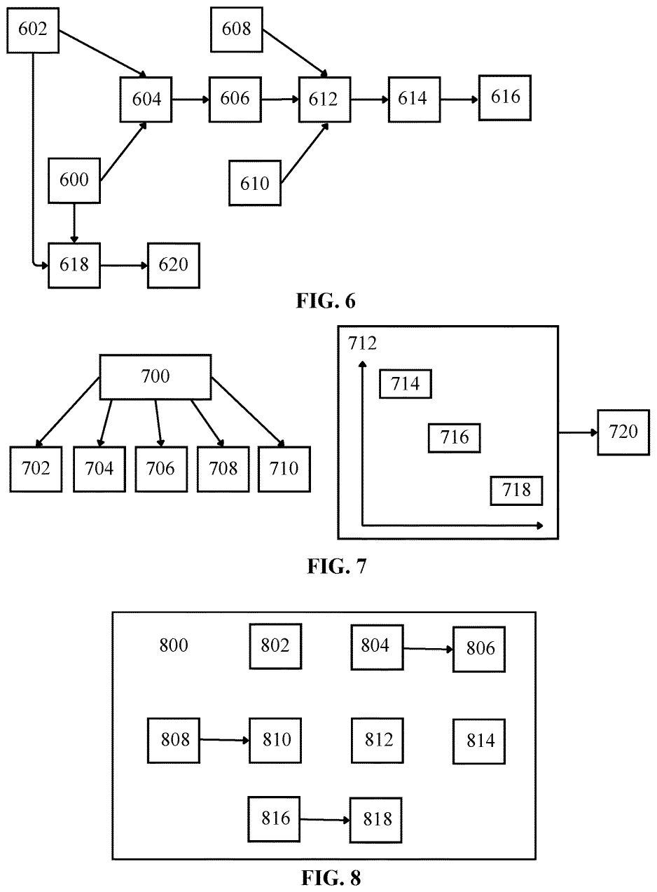

Referring generally to FIG. 6, an input operand A 600 and a correction factor 602 may be provided to an extended-precision pre-multiply block 604, which yields an unrounded scaled operand 606. The unrounded scaled operand 606, together with input operand B 608 and input addend C 610, is supplied to a fused multiply-add core 612. A final rounding block 614 generates a final result 616.

In contrast, a software execution path 618 may produce an intermediate rounded value 620 after applying the correction factor in a separate multiply operation. That intermediate rounded value may then be used in a subsequent multiply-add operation, thereby introducing an additional rounding event relative to the preferred in-pipeline hardware path disclosed herein.

In preferred embodiments, the in-pipeline pre-multiply arithmetic is performed in extended precision relative to the external operand representation. For example, FP16 inputs may be processed using a wider internal representation, and FP32 inputs may likewise be processed using a wider internal representation. The exact internal width may vary by implementation.

In certain embodiments, the reduction or elimination of intermediate architectural rounding contributes to deterministic output behavior and reduced result variability across toolchains and execution paths. In preferred embodiments, a fixed pipeline location for scaling, an internal factor source, and a single architectural rounding path cooperate to provide bit-exact or substantially bit-identical execution behavior for repeated computations under the same hardware conditions and rounding mode.

Referring generally to FIG. 7, a precision-support block 700 may support one or more numeric formats, such as an FP16 path 702, BF16 path 704, TF32 path 706, FP32 path 708, and FP64 path 710. A PVT matrix 712 may represent validation or operating behavior over process-corner, voltage-range, and temperature-range variations represented by axes 714, 716, and 718, respectively.

In certain embodiments, an identical-hash output block 720 or equivalent result-comparison mechanism may be used to validate repeatability or reproducibility across multiple chips, multiple test runs, or multiple environmental operating points. Such validation may include direct result comparison, hash comparison, bitwise equivalence checks, or similar techniques.

In certain disclosed embodiments, representative operating conditions include a supply voltage range from about 0.65 volts to about 0.95 volts and a temperature range from about −40 degrees Celsius to about +125 degrees Celsius. These values are provided as representative examples of disclosed implementations and are not required in all embodiments.

In certain embodiments, the protected stored value may be represented using 16-bit fixed-point precision. Such a representation may provide sufficient precision for intended mixed-precision workloads in representative embodiments. In other embodiments, wider fixed-point precision, floating-point encoding, or direct encoded storage of the scaling factor may be used.

In certain embodiments, the scaling factor is derived once during initialization and then reused for many arithmetic operations. In other embodiments, the factor may be periodically refreshed, reloaded, reformatted, or redundantly stored to support resilience, fault tolerance, or multi-format execution paths.

In certain embodiments, the disclosed architecture may be integrated into a tensor-core cluster or other arithmetic subsystem in a GPU, AI accelerator, or scientific-computing ASIC. In some embodiments, the architecture uses an existing scheduler and memory interface while adding decode support and in-pipeline scaling resources.

Referring generally to FIG. 8, representative embodiments include a GPU embodiment 800, an ASIC embodiment 802, a systolic-array embodiment 804 including one or more processing elements 806, a chiplet embodiment 808 using a die-to-die interface 810, a mobile SoC embodiment 812, a secure programmable register embodiment 814, a multi-constant selector embodiment 816, and an integer tensor-core embodiment 818.

The embodiments of FIG. 8 are provided to illustrate alternative and optional implementations. The presence of these variants should not be understood to alter the identity of the core invention, which remains the in-pipeline application of a scaling factor within a fused multiply-add execution architecture.

In certain embodiments, a multi-constant selector embodiment may store multiple internal constants and use a control field to select among them. Such embodiments may support additional RP-derived constants or related scaling values. However, multi-constant support is optional and is not required for the base in-pipeline scaled fused multiply-add architecture.

In certain embodiments, integer or quantized arithmetic cores may apply analogous scaling techniques in fixed-point or integer arithmetic paths. Such embodiments are alternative implementations and may differ in arithmetic width, correction-factor representation, saturation behavior, accumulation paths, or quantization rules.

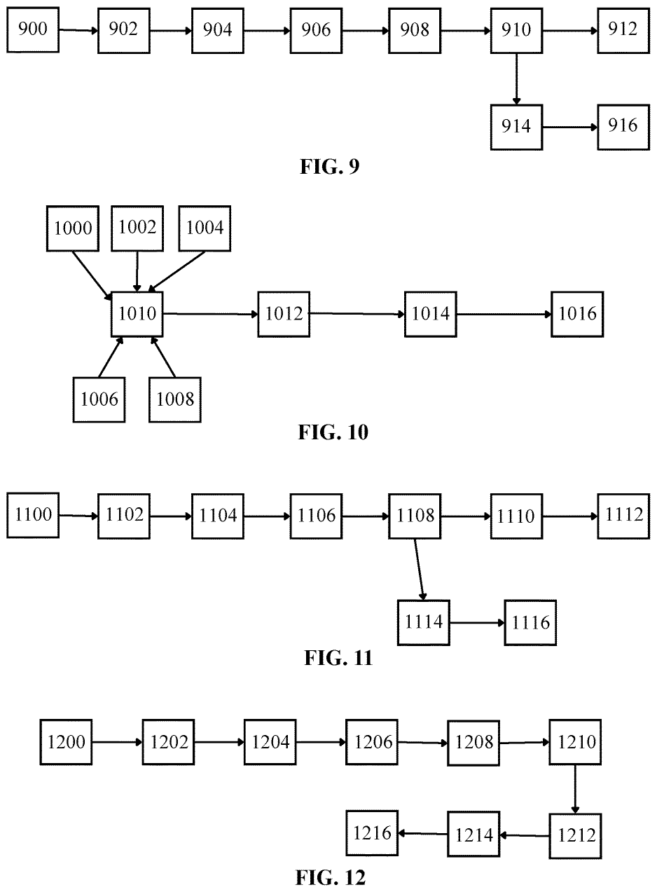

Referring generally to FIG. 9, a software and implementation flow may begin with source code 900 that invokes a compiler intrinsic 902 or other source-level construct. A compiler backend 904 may emit a micro-FMA opcode stream 908 through a scheduler interface 906. An RTL implementation 910 may embody the corresponding datapath and control logic, and a simulation and formal-verification block 912 may validate behavior before a programmed device image 914 is deployed to hardware 916.

In certain embodiments, a non-transitory computer-readable medium may store instructions that, when compiled or executed in an appropriate software and hardware environment, invoke the scaled fused multiply-add operation disclosed herein. In some embodiments, compiler support may be provided for languages such as C, C++, CUDA, Fortran, or other implementation environments.

Referring generally to FIG. 10, representative downstream applications may include a DFT kernel 1000, a molecular-dynamics kernel 1002, a GW kernel 1004, a gravity kernel 1006, and an AI inference block 1008. A scaled-operand insertion point 1010 may direct selected operations to a micro-FMA execution path 1012 to produce a corrected result output 1014 and, in some embodiments, a reproducibility hash output 1016.

These downstream applications illustrate representative contexts in which the disclosed arithmetic architecture may be useful. They are not required to practice the core invention and should not be understood as limiting the architecture to any particular application domain.

Referring generally to FIG. 11, a manufacturing and provisioning flow may include a design package 1100, a fuse-image generator 1102, an optional signature block 1104, a wafer-sort programmer 1106, a programmed die 1108, a reset-load event 1110, a verification interface 1112, a deployed accelerator 1114, and an audit record 1116.

In certain embodiments, a protected stored value is programmed at wafer sort and subsequently loaded into internal storage during initialization. In some embodiments, provisioning records, verification records, or audit records may be maintained for device tracking or trusted deployment. Such records are optional and do not define the core arithmetic mechanism.

Referring generally to FIG. 12, a representative validation flow may include a formal-verification block 1200, a timing-validation block 1202, a single-rounding check 1204, an energy-measurement block 1206, a PVT-cycling block 1208, a multi-chip execution block 1210, a hash-comparison block 1212, and an acceptance-criteria block 1214 yielding a validated implementation output 1216.

In certain embodiments, formal verification may include machine-checked verification of the corrected fused multiply-add expression, consistency between the scaled hardware operation and a corresponding RP correction formulation, proof that delta_loop is bounded between zero and one, proof that (1−delta_loop) is bounded between zero and one, proof that the RP-specific factor is parameter-free in the disclosed formulation, and proof that the micro-FMA operation is deterministic as a function.

In certain embodiments, the disclosed mathematical and formal-verification support may correspond to theorem statements including micro_fma_correct, scaling_consistent, micro_fma_reduces_to_fma, delta_loop_bounds, loop_multiplier_bounds, parameter_free, and bit_exact. Such theorem names are provided to identify categories of formal support and may correspond to formal verification artifacts, source files, or proof modules.

In certain embodiments, engineering validation may include RTL verification, simulation, timing analysis, power analysis, area analysis, silicon measurement, or combinations thereof. In representative disclosed embodiments, such engineering validation supports example results concerning latency, factor precision, storage integrity, area overhead, energy savings, and performance behavior.

In certain representative implementations, the scaled fused multiply-add path may operate with the same cycle count as the unscaled fused multiply-add path, may exhibit reduced dynamic energy per scaled operation relative to a software scaling path, and may provide improved reproducibility across repeated or cross-device computations. These are representative disclosed behaviors and need not be present in identical form in all embodiments.

In certain embodiments, example workload validation may include DFT exchange-correlation kernels, molecular dynamics force evaluation, AI inference with RP-calibrated values, GW screening operations, gravity-kernel multiplies, or cross-chip result-hash comparison tests. Such examples are representative and illustrative.

In one representative DFT example, correction scaling may be applied to selected exchange-correlation operations so that hardware-executed scaling replaces a separate software multiply operation. In one representative molecular-dynamics example, selected Coulomb or Lennard-Jones operations may similarly use the disclosed micro-FMA path. In one representative GW example, selected screening or self-energy operations may use the disclosed path. In one representative gravity example, selected kernel-multiply operations may use the disclosed path. In one representative AI example, selected scaled operations in an inference pipeline may use the disclosed path.

In certain embodiments, validation may include executing the same workload on multiple devices and comparing bit patterns or hashes. In representative disclosed examples, hardware in-pipeline scaling may produce identical output hashes across multiple devices where software scaling may produce variation due to different rounding paths or execution ordering.

In certain embodiments, acceptance criteria may include one or more of: unchanged cycle count relative to a baseline fused multiply-add path, absence of an intermediate architectural rounding step, successful provision and loading of the correction value, successful generation of an internal scaling factor, successful deterministic output comparison, reduced energy relative to a software scaling baseline, or successful operation over selected process, voltage, or temperature ranges.

The present disclosure therefore provides, in various embodiments, an integrated circuit and associated methods in which a correction factor is brought under hardware control and applied within a fused multiply-add pipeline, thereby enabling corrected arithmetic execution without reliance on a separate software-visible scaling multiply.

Although numerous embodiments and examples have been described, these embodiments and examples are illustrative and not limiting. Features described in connection with one embodiment may be used with other embodiments unless inconsistent therewith. The scope of protection is defined by the claims.

In certain embodiments, the core inventive architecture disclosed herein includes: (i) a fused multiply-add execution pipeline; (ii) a protected internal source of a scaling factor; (iii) control logic configured to invoke a scaled fused multiply-add execution path; (iv) an in-pipeline pre-multiply stage configured to apply the scaling factor to a selected multiplicand before completion of the fused multiply-add operation; and (v) a result path configured to generate a corrected fused multiply-add result. In preferred embodiments, the corrected path is executed without a separate software-visible scaling multiply instruction.

In preferred embodiments, the identity of the invention resides in the in-pipeline scaling of a selected fused multiply-add multiplicand using an internally supplied factor at a fixed point in the arithmetic pipeline. Optional embodiments, alternative storage approaches, optional security features, downstream applications, and future platform variants do not alter the identity of the core invention.

In certain embodiments, the disclosed architecture may be understood at three levels of implementation specificity. At a first level, a protected internal scaling factor is applied within a fused multiply-add pipeline to generate a corrected result. At a second level, the scaling factor is fixed for hardware execution, supplied from a non-user-accessible internal source, and applied at a fixed point in the pipeline so that the corrected operation is not implemented as a separate software scaling multiply. At a third level, the scaling factor is specifically equal to (1−delta_loop), where delta_loop is defined according to the RP-specific formulation disclosed herein.

In the disclosed RP-specific embodiment, delta_loop is fully determined as: delta_loop=X_opt\hat{ }(1+R_RP)where X_opt=phi/pi and R_RP=7/12. Accordingly, in that RP-specific embodiment, the scaling factor (1−delta_loop) is likewise fully determined by the stated parameters and is not selected from an arbitrary family of unrelated factors.

In certain embodiments, the protected internal source of the scaling factor may be characterized by a hierarchy of implementation features. At a broad level, the source is internal to the integrated circuit and is used by arithmetic hardware without requiring a separate software-visible scaling multiply. At a narrower level, the source is non-user-accessible. At a still narrower level, the source is nonvolatile or protected initialization storage. In preferred embodiments, the source is one-time-programmable storage programmed prior to field deployment.

In certain embodiments, the disclosed architecture is configured so that software, user-mode code, application-level kernels, or other external logic need not fetch a software-visible correction constant and need not issue a separate multiply instruction to apply the correction. Rather, the corrected fused multiply-add behavior is invoked through an instruction, micro-op, or control representation that causes the arithmetic hardware itself to perform the scaling action in the execution pipeline.

In certain embodiments, the disclosed architecture may be implemented using explicit hardware modules including, by way of example and not limitation: a protected factor store; initialization logic; one or more factor derivation circuits; one or more scaling registers; an instruction decoder; an issue controller or scheduler; operand routing logic; a pre-multiply arithmetic block; a fused multiply-add core; writeback logic; and optional diagnostic or verification logic.

In certain embodiments, the inputs to the disclosed corrected fused multiply-add path include: a first multiplicand; a second multiplicand; an addend; a control value identifying or invoking scaled fused multiply-add execution; and a protected stored value or derived scaling factor used for in-pipeline correction. In certain embodiments, the outputs include: a fused multiply-add result; optional internal state updates; optional diagnostic verification data; optional result-comparison data; and optional implementation artifacts such as instruction encodings, programmed device images, or verification outputs.

In one representative operational sequence, an instruction stream provides a scaled fused multiply-add invocation; decode logic recognizes the invocation; scheduling logic issues the operation to an arithmetic execution unit; a protected internal factor is retrieved from a scaling register or equivalent source; a selected multiplicand is scaled in an in-pipeline pre-multiply stage; the scaled multiplicand is provided to a fused multiply-add core together with a second multiplicand and addend; and a corrected result is generated and written back through a result path.

In certain embodiments, the disclosed architecture supports a broad corrected fused multiply-add expression of the form:

result=(A×S)×B+C

where S is an internally supplied scaling factor.

In narrower embodiments, S is a fixed factor derived from a protected stored value. In still narrower embodiments, S is equal to (1−delta_loop). This layered presentation is intended to preserve broader architectural support while also preserving narrower fallback support for the RP-specific implementation.

In certain embodiments, the scaling factor is maintained in one or more internal numeric representations appropriate for the arithmetic path in which it is used. Such representations may include fixed-point and floating-point forms and may be precomputed, derived at reset, derived at boot, derived at initialization, or derived on demand. In preferred embodiments, one or more preformatted internal representations are stored in non-user-accessible scaling registers for direct use by the pre-multiply arithmetic block.

In certain embodiments, the factor source hierarchy may include: a protected internal factor source; a non-user-accessible factor source; a nonvolatile factor source; a one-time-programmable factor source; and a redundancy-protected one-time-programmable factor source. Different claims may be directed to different levels of this hierarchy, and the disclosure of narrower embodiments should not be understood as narrowing the broader architecture unless expressly required by a claim.

In certain embodiments, the protected stored value is delta_loop and the internally used scaling factor is (1−delta_loop). In other embodiments, the protected stored value may directly represent (1−delta_loop). In still other embodiments, both values may be stored, computed, cross-checked, redundantly stored, or represented in different formats for different arithmetic paths. The invention is not limited to a single internal representation so long as the arithmetic hardware is provided with the intended scaling factor for in-pipeline operation.

In certain embodiments, the correction factor is applied at a fixed point in the pipeline before completion of the multiply-add operation. In preferred embodiments, the fixed point is located before the main fused multiply-add multiplication stage so that the selected multiplicand is scaled before entry into the multiply-add datapath. This fixed-location execution supports predictable arithmetic behavior and distinguishes the disclosed architecture from software-visible pre-scaling sequences.

In preferred embodiments, the corrected fused multiply-add operation is executed through a single architectural rounding path. More particularly, the selected multiplicand is first scaled in internal arithmetic and the resulting scaled multiplicand is then consumed by the fused multiply-add core, with architectural rounding occurring after fused multiply-add completion rather than after a separate software-visible scaling multiply.

In a representative software path, a first operation computes A×S and produces a rounded intermediate value, after which a second operation computes intermediate×B+C and produces a rounded result. In a representative preferred hardware path disclosed herein, the operation computes a scaled version of A in internal arithmetic and then computes the fused multiply-add result through a single architectural rounding path. The disclosed in-pipeline path thereby avoids the separate intermediate architectural rounding step characteristic of the representative software path.

In certain embodiments, the absence of an intermediate architectural rounding step may reduce rounding-path variability relative to representative software implementations. In preferred embodiments, the combination of fixed in-pipeline scaling location, protected internal factor sourcing, and single architectural rounding supports deterministic or bit-exact result behavior for repeated execution under the same hardware conditions and rounding mode.

In certain embodiments, the disclosed architecture supports a hierarchy of deterministic-execution behavior. At a broad level, the architecture reduces additional variability associated with separate software scaling operations. At a narrower level, the architecture removes an intermediate architectural rounding step from the corrected execution path. At a still narrower level, the architecture supports bit-identical results across repeated executions and, in representative disclosed validations, across multiple devices and selected operating conditions.

In certain embodiments, the preferred unchanged-latency execution may likewise be described in a hierarchy. At a broad level, the corrected execution path does not require a separate software-visible multiply instruction. At a narrower level, the corrected path does not expose an additional architectural execution stage to software. At a still narrower level, in the preferred disclosed implementation, the corrected path adds zero additional clock cycles relative to a corresponding unscaled fused multiply-add path.

In certain representative implementations, a standard fused multiply-add path may be viewed as a four-stage path including fetch, align, multiply, and add-and-round. In corresponding preferred corrected implementations, the scaled fused multiply-add path may likewise be viewed as a four-stage path in which the scaling action is absorbed into the align stage or another preexisting stage, thereby preserving the overall cycle count.

In certain representative implementations, the scaling action may be performed by a dedicated DSP slice or equivalent arithmetic resource within the pre-multiply stage. In other embodiments, equivalent local arithmetic resources may be used. The specific hardware resource selected for pre-multiply scaling may vary by implementation and is not required to define the broad architecture.

In certain embodiments, the preferred factor storage precision is 16-bit fixed point. In one representative RP-specific implementation, this precision is sufficient to represent delta_loop or (1−delta_loop) at a level suitable for intended mixed-precision workloads. In other embodiments, wider fixed-point precision, floating-point encoding, or direct encoded constant storage may be used.

In certain representative embodiments, the disclosed architecture may support one or more of FP16, BF16, TF32, FP32, and FP64 arithmetic paths. In preferred embodiments, one or more internal representations of the scaling factor are prepared so that the selected numeric path can consume an appropriate format without requiring software-visible factor conversion.

In certain embodiments, operand selection may be implemented through a hierarchy of alternatives. At a broad level, a selected multiplicand is scaled. At a narrower level, one of two multiplicands is selected by control logic. At a still narrower level, the first multiplicand is scaled. In preferred embodiments, operand A is the scaled multiplicand. In alternative embodiments, operand B is scaled, or both multiplicands are scaled.

In certain embodiments, the preferred use of operand A may be supported by compiler, backend, microcode, or scheduler logic that arranges for a correction-bearing or correction-associated multiplicand to be placed in the first multiplicand position. However, such compiler-directed placement is not required in all embodiments and should not be understood as limiting the hardware architecture unless expressly recited in a claim.

In certain embodiments, a middle-tier fallback implementation may employ a protected internal scaling factor derived from a stored value and applied at a fixed point within the fused multiply-add pipeline, without requiring that the factor be defined in terms of the full RP-specific formulation. In narrower embodiments, the RP-specific formulation is used. This disclosure is intended to support both the broader architectural implementation and the narrower RP-specific implementation.

Although representative embodiments are described using one-time-programmable storage, scaling registers, decode logic, scheduler logic, and pre-multiply arithmetic blocks, the invention encompasses equivalent internal implementations of the protected factor source, control path, factor-derivation logic, operand-routing logic, and in-pipeline scaling mechanism. The particular internal circuitry, storage technology, control encoding, and arithmetic-resource arrangement may vary by implementation so long as the correction factor is applied within the fused multiply-add execution path itself, rather than by a separate software-visible scaling multiply instruction. Accordingly, architectural equivalents that preserve in-pipeline corrected fused multiply-add execution are within the scope of the present disclosure.

In certain embodiments, the protected factor source may be loaded or refreshed according to an initialization workflow including: programming of the source value during fabrication or provisioning; loading during reset, boot, or initialization; derivation of one or more execution-format scale values; optional integrity checking; and storage of the resulting scale value in an internal scaling register for use by the arithmetic datapath.

In certain embodiments, initialization or provisioning may further include one or more optional refinement or verification branches, including: authentication of the programmed value; hash generation; parity checking; redundancy checking; comparison of independently derived representations; and confirmation that the factor value loaded into the execution path matches an expected value or expected derivative. Such branches are optional and may be used in selected implementations.

In certain embodiments, a manufacturing and provisioning workflow may include generation of a fuse image or protected constant image, optional authentication of that image, programming of the image into protected storage during manufacturing, initialization loading of the programmed value into internal execution registers, optional generation of a verification output, and deployment of the programmed integrated circuit into a compute device.

In certain embodiments, protected provisioning and verification of the stored correction value or a derivative thereof may be used to provide traceable hardware integrity for corrected fused multiply-add execution in regulated, audited, or otherwise verification-sensitive environments.

In certain embodiments, one or more output products of the disclosed design and implementation flow may include: a hardware design description; an RTL implementation; a micro-op or opcode specification; a compiler intrinsic or software interface; a programmed integrated circuit; a protected constant image; a diagnostic hash output; and verification artifacts demonstrating arithmetic, timing, or reproducibility behavior.

In certain embodiments, the disclosed architecture may be implemented in a GPU or ASIC tensor-core environment with representative process and physical characteristics. By way of non-limiting example, a representative disclosed implementation may be fabricated at a 5 nm process node and may exhibit an area overhead on the order of 0.023 mm2 per tensor core. Such values are representative of disclosed example implementations and are not required in all embodiments.

In certain representative implementations, the preferred corrected fused multiply-add path may exhibit the same overall cycle count as a standard fused multiply-add path, a static power increase on the order of about 0.7 percent, and reduced dynamic energy per scaled operation relative to a representative software scaling path. Such values are representative engineering values disclosed for example implementations and are not universal limitations.

In one representative energy comparison, a software scaling path may include energy contributions associated with a factor fetch, a separate multiply operation, a fused multiply-add operation, and writeback, while a preferred corrected in-pipeline path may reduce or eliminate the separate fetch and software-visible multiply overhead. In one representative disclosed example, the energy per scaled operation may be approximately 92 pJ for a software path and approximately 63 pJ for an in-pipeline path, corresponding to about 31.5 percent savings. These values are illustrative disclosed examples only.

In certain representative workload scenarios, the reduction in per-operation overhead may produce overall kernel-level energy and throughput benefits. In one representative disclosed scenario in which about 10 percent of fused multiply-add operations require correction scaling, overall energy reduction may be on the order of about 3.15 percent and wall-time recovery may be on the order of about 1.8 percent. In another representative disclosed scenario in which about one-third of operations require correction scaling, overall energy reduction may be on the order of about 10.4 percent and FLOP-per-watt improvement may approach about 1.18×. Such values are illustrative example results and are not mandatory features of all embodiments.

In certain embodiments, validation logic or engineering validation flows may use explicit acceptance criteria. Representative acceptance criteria may include one or more of: successful loading of the protected factor value; successful derivation of one or more scaling formats; successful assertion of the scale-control path upon instruction decode; successful in-pipeline scaling of a selected multiplicand; absence of an intermediate architectural rounding step in the preferred path; unchanged cycle count relative to a baseline fused multiply-add path in the preferred implementation; deterministic output agreement across repeated runs; successful operation over selected voltage and temperature ranges; and energy reduction relative to a representative software scaling baseline.

In certain embodiments, a formal-verification acceptance flow may require confirmation that the corrected hardware operation matches the intended mathematical operation, that the disclosed RP-specific constant definition is internally consistent, that delta_loop remains bounded between zero and one, that (1−delta_loop) remains bounded between zero and one, and that the corrected execution path is deterministic as a function. Such criteria may be satisfied by formal proof artifacts, theorem statements, or machine-checked proofs.

In certain embodiments, engineering validation may include a timing-validation flow in which a baseline fused multiply-add pipeline and a corrected fused multiply-add pipeline are compared for cycle count, issue timing, and stage occupancy. Acceptance of the preferred unchanged-latency implementation may require demonstration that the corrected path completes in the same number of cycles as the baseline path.

In certain embodiments, reproducibility validation may include executing the same workload repeatedly on the same device or on multiple devices and comparing output bit patterns or derived hashes. Acceptance may require exact match, selected tolerance thresholds, or a target difference criterion, depending on the implementation and validation regime. In representative preferred embodiments, exact hash agreement is used as an acceptance criterion.

In certain embodiments, environmental validation may include operation across selected process, voltage, and temperature conditions. A representative acceptance flow may require successful execution over a voltage range of about 0.65 volts to about 0.95 volts and a temperature range of about −40 degrees Celsius to about +125 degrees Celsius, with no detected functional failure and, in preferred embodiments, no bitwise output divergence relative to a reference output.

In certain embodiments, the disclosed architecture may be used in a representative DFT exchange-correlation kernel. In such an example, selected correction-bearing operations are directed to the scaled fused multiply-add path so that the scaling action is absorbed into arithmetic hardware rather than performed as a separate software-visible multiply. In a representative disclosed workload, this arrangement may preserve wall time relative to an unscaled hardware path while avoiding overhead associated with a separate software multiply.

In certain embodiments, the disclosed architecture may be used in a representative molecular-dynamics force-evaluation kernel. In such an example, selected Coulomb and/or Lennard-Jones correction-bearing operations are executed through the scaled fused multiply-add path. In one representative disclosed example, the corrected hardware path may avoid a wall-time penalty otherwise associated with software-visible correction scaling and may reduce energy relative to the software scaling path.

In certain embodiments, the disclosed architecture may be used in a representative AI inference pipeline. In such an example, selected scaling operations associated with inference layers, calibration values, or corrected parameters are directed to the scaled fused multiply-add path. In one representative disclosed example, the corrected hardware path may reduce latency and energy relative to software scaling while preserving the intended corrected computation.

In certain embodiments, the disclosed architecture may be used in a representative GW screening or self-energy calculation. In such an example, selected multiply-add operations associated with a correction-bearing screening operator are directed to the scaled fused multiply-add path. In one representative disclosed example, the corrected hardware path permits execution of the corrected operation at a cost comparable to or closer to that of an unscaled hardware path than would be achieved by a software scaling sequence.

In certain embodiments, the disclosed architecture may be used in a representative gravity-kernel multiply operation. In such an example, selected kernel-times-density multiply-add operations are directed to the scaled fused multiply-add path so that correction scaling is absorbed into the arithmetic pipeline. In one representative disclosed example, the corrected hardware path reduces latency and energy relative to a software scaling implementation.

In certain embodiments, reproducibility validation may include a representative cross-chip verification example in which the same workload is executed on multiple devices and the resulting outputs are compared directly or by hash. In one representative disclosed example, the hardware in-pipeline path may produce identical output hashes across multiple tested devices, while a software scaling path may exhibit divergence due to execution-order or rounding-path differences.

In certain embodiments, a compiler or toolchain flow may include: receiving source-level code invoking a corrected fused multiply-add operation; selecting a compiler intrinsic, built-in, library call, or backend transformation associated with scaled fused multiply-add execution; emitting an instruction or micro-op sequence invoking the corrected hardware path; and arranging operand placement so that the selected multiplicand is presented on the intended input path of the arithmetic datapath.

In certain embodiments, a non-transitory computer-readable medium may store instructions that, when processed by a compiler, runtime, loader, or processor environment, invoke the corrected fused multiply-add operation of the disclosed architecture. In certain embodiments, a programmed integrated circuit may embody the protected factor source, decode logic, scaling path, fused multiply-add core, and result path described herein.

In certain embodiments, a claim-support hierarchy may be derived from the present disclosure. At a broad level, the disclosure supports a method of performing in-pipeline scaling of a selected multiplicand within a fused multiply-add pipeline. At a narrower level, the disclosure supports a system including a protected internal factor source, control logic, an in-pipeline scaling stage, and a fused multiply-add core. At a still narrower level, the disclosure supports RP-specific implementations using delta_loop as defined herein. At additional levels, the disclosure supports non-transitory computer-readable media and programmed integrated-circuit embodiments.

In certain embodiments, optional security or verification features such as one-time-programmable storage, redundancy, authentication, diagnostic hashing, audit records, or external verification mechanisms may be used to strengthen integrity, trust, or traceability of the protected factor source. Such features are subordinate to the core arithmetic mechanism and should not be understood as required unless expressly recited in a claim.

In certain embodiments, alternative platform implementations may include systolic arrays, chiplets, integer tensor cores, and mobile-system embodiments. These implementations may reuse the core concept of protected internally supplied in-pipeline scaling, but they may differ in arithmetic width, operand routing, storage format, power constraints, scheduling logic, and local datapath organization. These alternative platform embodiments are disclosed to preserve implementation flexibility and future claim support.

In certain embodiments, prophetic validation pathways may be pursued for future implementations. Such prophetic pathways may include fabrication of a test chip, execution of representative DFT or MD workloads on that test chip, thermal cycling across selected temperature ranges, radiation testing of protected storage, and multi-chip reproducibility testing across a larger set of devices. These prophetic pathways are disclosed as future or additional validation programs and should not be construed as limiting the presently described embodiments.

In one representative prophetic validation pathway, a test chip including corrected fused multiply-add hardware may be fabricated and benchmarked for throughput, latency, and energy behavior relative to a representative software scaling baseline. In another representative prophetic validation pathway, a large plurality of devices may be tested using identical workloads and hash-based comparison to validate cross-device reproducibility. In another representative prophetic validation pathway, protected storage may be subjected to radiation or environmental stress testing to evaluate resilience. These pathways are illustrative future validation examples.

In all such embodiments, examples, and alternative implementations, the disclosed invention remains centered on the use of a protected internal correction factor applied within a fused multiply-add execution pipeline to produce a corrected fused multiply-add result without reliance on a separate software-visible scaling multiply. Narrower embodiments may further require a fixed pipeline application point, a single architectural rounding path, unchanged cycle count, or an RP-specific scaling-factor definition, as set forth elsewhere herein and as may be recited in the claims.

In order to preserve clarity of disclosure, the present specification distinguishes among multiple levels of subject matter support. The core invention is the in-pipeline application of a protected internally supplied scaling factor to a selected multiplicand within a fused multiply-add execution path. Preferred embodiments include, by way of example, one-time-programmable storage, reset-time loading, operand-A scaling, extended-precision pre-multiplication, and unchanged cycle count relative to a baseline fused multiply-add path. Optional embodiments include alternate factor-storage formats, alternate numeric formats, optional diagnostic hashing, optional authentication, and optional verification flows. Alternative embodiments include operand-B scaling, dual-multiplicand scaling, programmable secure registers, systolic-array implementations, integer-core implementations, chiplet implementations, and mobile implementations. Prophetic embodiments include future test-chip, environmental, radiation, and large-scale reproducibility validation programs. Downstream embodiments include scientific, simulation, AI, regulatory, and deployment uses of the disclosed arithmetic architecture. The inclusion of any non-core embodiment does not alter the identity of the core invention.

In certain embodiments, the presently disclosed RP-specific implementation is supported not merely as an illustrative use of a scaling factor, but as a mathematically determined embodiment in which delta_loop and the corresponding scaling factor are fixed by the disclosed formulation. In such RP-specific embodiments, the formal verification material described herein supports correctness of the corrected fused multiply-add expression, consistency between the arithmetic implementation and the disclosed RP correction formulation, deterministic function behavior of the corrected operation, and the parameter-free character of the disclosed RP-specific factor definition.

In one aspect, the present disclosure supports a method of executing a corrected fused multiply-add operation, the method comprising supplying a scaling factor from a protected internal source, applying the scaling factor to a selected multiplicand within a fused multiply-add pipeline, performing a fused multiply-add operation using the scaled multiplicand, and producing a corrected result. In narrower embodiments, the method further comprises deriving the scaling factor from a protected stored value. In still narrower embodiments, the scaling factor is equal to (1−delta_loop) as defined herein.

In another aspect, the present disclosure supports an integrated circuit comprising a fused multiply-add execution pipeline, a protected internal factor source, control logic configured to invoke a corrected fused multiply-add path, an in-pipeline scaling stage configured to apply the factor to a selected multiplicand, and a fused multiply-add core configured to generate a corrected result using the scaled multiplicand. In narrower embodiments, the integrated circuit further includes one-time-programmable storage, initialization load logic, factor-derivation logic, non-user-accessible scaling registers, and diagnostic verification logic.

In another aspect, the present disclosure supports a non-transitory computer-readable medium storing instructions that, when processed in a suitable software and hardware environment, invoke the corrected fused multiply-add operation disclosed herein. In certain embodiments, such instructions are emitted by a compiler, backend, assembler, runtime, or code-generation system in response to a source-level intrinsic, transformation rule, or recognized arithmetic pattern associated with corrected fused multiply-add execution.

In another aspect, the present disclosure supports a programmed device or programmed integrated circuit in which a protected stored value or derivative thereof is loaded into internal execution circuitry and used by arithmetic hardware to perform in-pipeline scaling of a selected multiplicand during fused multiply-add execution. In certain embodiments, the programmed device further supports verification outputs, protected initialization flows, or hardware-only access controls for the stored value or scaling factor.

In certain embodiments, selection and refinement logic may be used to prepare the corrected fused multiply-add path for execution. Such logic may include one or more of: selecting a numeric representation of the factor suitable for a target arithmetic format; selecting operand A, operand B, or both multiplicands for scaling; arranging compiler-or scheduler-directed operand placement; performing optional integrity or redundancy checks on a stored value or derived factor; generating multiple internal factor formats from a common stored value; and selecting among alternate internal factor representations based on datapath, precision, or execution context.

Where more than one multiplicand is eligible for correction-factor scaling, selection may be resolved according to a fixed hardware policy, an instruction-encoded selection field, a compiler-directed operand-placement policy, a scheduler policy, or another control mechanism. In preferred embodiments, operand A is selected by default. In other embodiments, the selected multiplicand is identified dynamically or explicitly by control state. Such selection mechanisms are provided to preserve implementation flexibility and should not be understood as limiting the broader architecture to a single operand-selection policy.

In certain embodiments, refinement of the protected internal factor may include deriving one or more alternate internal representations from a stored source value, performing optional comparison or cross-check operations between such representations, and selecting a representation for immediate execution use. In certain embodiments, such refinement may occur during reset, boot, initialization, context change, precision-mode change, or other implementation-defined events. Such refinement operations are optional implementation details and may be omitted where a directly usable stored factor representation is available.

In preferred one-time-programmable embodiments, the protected stored value is programmed prior to field deployment, loaded internally during initialization, and thereafter used by arithmetic hardware without being writable by ordinary software. In such preferred embodiments, the one-time-programmable storage provides a one-time-programmed, non-user-modifiable, hardware-controlled source of the correction value or scaling factor. In narrower preferred embodiments, the one-time-programmable source may be described as tamper-resistant or tamper-proof in the sense that it is not ordinarily rewritable after programming and is not directly exposed for user modification through normal software execution paths.

In preferred embodiments using one-time-programmable storage, the arithmetic architecture may therefore provide a protected and fixed hardware basis for in-pipeline corrected fused multiply-add execution. This preferred arrangement distinguishes the disclosed hardware path from software-visible schemes in which a correction factor is externally fetched, externally transformed, or externally multiplied prior to fused multiply-add execution.

In certain preferred implementations, the disclosed architecture may be integrated into an existing tensor-core or arithmetic-accelerator subsystem using an existing scheduler and existing memory interface while adding localized decode support and localized in-pipeline scaling resources. In such preferred implementations, the architecture may be regarded as a drop-in or minimally invasive enhancement to an existing fused multiply-add execution path, in the sense that corrected execution is added without requiring complete redesign of the surrounding accelerator fabric.

In certain embodiments, representative interface or subsystem structures may include existing memory-path, scheduler-path, issue-path, and execution-path resources that are reused by the corrected fused multiply-add architecture. In representative disclosed implementations, micro-op delivery may occur through an existing tensor-core scheduler, while only selected decode, control, storage, and arithmetic resources are added or modified to support the corrected execution path. Such integration details are representative of preferred implementation efficiency and are not required in all embodiments.

In certain embodiments, the present disclosure is further intended to preserve support for future claim families directed to continuation-worthy developments that remain rooted in the presently disclosed core arithmetic mechanism. Such future claim families may include, by way of example and not limitation: multi-constant corrected fused multiply-add families; programmable secure factor-register families; integer or fixed-point corrected multiply-add families; systolic-array and processing-element families; chiplet and package-level integration families; and low-power or mobile corrected arithmetic families.

The continuation-worthy future targets identified herein are disclosed as extensions of the core concept of protected internally supplied in-pipeline scaling for corrected fused multiply-add execution. Such future targets should not be understood as redefining the present invention, but rather as preserving support for later claim development directed to implementations that share the same underlying arithmetic architecture and control principles.

In certain embodiments, demonstrated or validated material may be distinguished from prophetic material as follows. Demonstrated or validated material includes formal proof support, representative disclosed hardware flows, representative disclosed timing behavior, representative disclosed engineering measurements or RTL validations, and representative disclosed workload examples. Prophetic material includes future test-chip fabrication programs, future environmental or radiation stress programs, and future large-scale reproducibility programs not yet characterized as completed validations. This distinction is made to preserve clarity of support level and not to limit the ability to claim subject matter adequately supported by the present disclosure.

In certain embodiments, downstream scientific, simulation, AI, regulatory, audit, and deployment uses are preserved as subordinate uses of the disclosed arithmetic architecture. Such downstream uses may inform utility, implementation context, and dependent claim support, but they do not replace or expand the identity of the core invention beyond the protected internally supplied in-pipeline scaling architecture disclosed herein.

In one representative system embodiment, an integrated circuit comprises a protected internal factor source, initialization logic configured to load or derive a scaling factor from the protected internal factor source, decode logic configured to recognize a corrected fused multiply-add invocation, control logic configured to issue the corrected fused multiply-add invocation to an arithmetic execution path, an in-pipeline scaling stage configured to apply the scaling factor to a selected multiplicand, a fused multiply-add core configured to perform a multiply-add operation using the scaled multiplicand, and a result path configured to output a corrected fused multiply-add result.

In certain representative system embodiments, the protected internal factor source comprises one-time-programmable storage, secure internal storage, nonvolatile storage, privileged storage, or another internal storage structure that is not ordinarily writable by application software during normal operation. In narrower preferred embodiments, the integrated circuit further comprises one or more scaling registers, one or more factor-formatting circuits, optional diagnostic verification logic, and optional redundancy or integrity-check structures.

In one representative method embodiment, a method comprises storing or otherwise providing a protected internal value associated with a correction factor, loading or deriving a scaling factor for arithmetic execution, recognizing a corrected fused multiply-add invocation, selecting a multiplicand for in-pipeline scaling, applying the scaling factor to the selected multiplicand within a fused multiply-add execution path, performing a fused multiply-add operation using the scaled multiplicand, and outputting a corrected result.

In narrower representative method embodiments, the method further comprises one or more of: formatting the scaling factor for a selected arithmetic precision; selecting among multiple operand-scaling policies; verifying integrity of a stored value or derived factor; generating a diagnostic verification output; comparing output values or hashes across repeated executions; or confirming unchanged cycle count relative to a baseline fused multiply-add path in a preferred implementation.

In one representative product or output embodiment, the present disclosure supports output products generated during design, compilation, provisioning, verification, or deployment of the disclosed architecture. Such output products may include, by way of example and not limitation: a micro-op or opcode encoding for corrected fused multiply-add execution; a compiler-generated instruction stream invoking corrected fused multiply-add execution; an RTL description or synthesized hardware implementation; a programmed integrated circuit image; a fuse image, provisioning image, or protected constant image; a diagnostic verification output; a reproducibility hash or comparison artifact; and a validation record associated with corrected fused multiply-add behavior.

In certain embodiments, a non-transitory computer-readable medium may store any one or more of the foregoing output products in machine-readable or tool-readable form, including instruction encodings, compiler outputs, hardware description artifacts, verification artifacts, provisioning artifacts, or deployment artifacts associated with the disclosed corrected fused multiply-add architecture.

The representative embodiments described herein may be organized into examples of different support levels. In certain instances, examples may correspond to representative implemented or validated embodiments. In other instances, examples may correspond to representative optional or alternative embodiments. In still other instances, examples may correspond to prophetic embodiments directed to expected future implementations, validation pathways, or platform expansions. Unless expressly stated otherwise, the inclusion of an example is not intended to elevate that example above the core invention defined by the protected internally supplied in-pipeline scaling architecture disclosed herein.

Representative examples described in this specification may therefore include, by way of example and not limitation, corrected fused multiply-add execution in representative tensor-core pipelines, representative initialization and provisioning flows, representative numeric and timing behaviors, representative application workloads, representative reproducibility tests, and representative future implementation or validation pathways. Such examples are provided to enable and illustrate the disclosed invention and should not be construed as restricting the claims to only the exact examples recited.

The Detailed Description set forth herein provides representative solution architectures corresponding to the execution problems identified in the Background. The disclosed embodiments are presented with sufficient structural, operational, and implementation detail to support make-and-use understanding of the corrected fused multiply-add architecture, while preserving flexibility for broader, narrower, fallback, optional, alternative, downstream, and continuation-oriented claim positions.

What is claimed is:

1. An integrated circuit comprising:
a fused multiply-add execution pipeline;
a protected internal factor source configured to provide a scaling factor for arithmetic execution;
control logic configured to invoke a corrected fused multiply-add operation;
an in-pipeline scaling stage configured to apply the scaling factor to a selected multiplicand within the fused multiply-add execution pipeline; and
a fused multiply-add core configured to generate a corrected result using the scaled multiplicand.

2. The integrated circuit of claim 1, wherein the corrected fused multiply-add operation is executed without a separate software-visible scaling multiply instruction.

3. The integrated circuit of claim 1, wherein the in-pipeline scaling stage is located at a fixed point in the fused multiply-add execution pipeline before completion of the fused multiply-add operation.

4. The integrated circuit of claim 1, wherein the corrected result is produced through a single architectural rounding path.

5. The integrated circuit of claim 4, wherein the in-pipeline scaling stage is configured to scale the selected multiplicand without an intermediate architectural rounding step prior to execution by the fused multiply-add core.

6. The integrated circuit of claim 1, wherein the protected internal factor source comprises one-time-programmable memory or non-user-accessible internal storage.

7. The integrated circuit of claim 1, wherein the corrected fused multiply-add operation adds zero additional clock cycles relative to a corresponding unscaled fused multiply-add operation.

8. The integrated circuit of claim 1, wherein the scaling factor is equal to (1−delta_loop).

9. The integrated circuit of claim 8, wherein:
delta_loop=X_opt\hat{ }(1+R_RP),
X_opt=phi/pi, and
R_RP=7/12.

10. The integrated circuit of claim 1, wherein the in-pipeline scaling stage uses extended-precision internal arithmetic relative to an external operand format.

11. The integrated circuit of claim 6, further comprising initialization logic configured to load a stored value from the one-time-programmable memory during initialization of the integrated circuit and derive the scaling factor therefrom.

12. The integrated circuit of claim 1, wherein the fused multiply-add execution pipeline supports one or more of FP16, BF16, TF32, FP32, and FP64 arithmetic execution.

13. The integrated circuit of claim 1, further comprising diagnostic logic configured to output verification information corresponding to a stored value or derivative thereof without exposing a raw stored factor value.

14. The integrated circuit of claim 1, wherein the control logic is configured to select either a first multiplicand or a second multiplicand for in-pipeline scaling.

15. The integrated circuit of claim 1, wherein the integrated circuit is implemented as a chiplet configured for package-level integration with a host processor, accelerator, GPU, or ASIC device.

16. The integrated circuit of claim 1, wherein the protected internal factor source is configured to store multiple scaling factors, and wherein the control logic is configured to select among the multiple scaling factors for application by the in-pipeline scaling stage.

17. The integrated circuit of claim 6, wherein the one-time-programmable memory comprises redundancy-protected one-time-programmable storage.

18. The integrated circuit of claim 1, wherein the control logic and the in-pipeline scaling stage are configured to implement a tensor-core corrected fused multiply-add micro-op using an internal scaling register that holds or derives (1−delta_loop) for scaling operand A within the fused multiply-add execution pipeline with zero additional clock cycles relative to a corresponding unscaled fused multiply-add operation.

19. The integrated circuit of claim 1, wherein protected provisioning or verification of a stored value or derivative thereof includes authenticated provisioning data or authenticated verification output corresponding to the scaling factor.

20. A method comprising:
providing a scaling factor from a protected internal factor source of an integrated circuit;
recognizing a corrected fused multiply-add invocation;
applying the scaling factor to a selected multiplicand within a fused multiply-add execution pipeline;
performing a fused multiply-add operation using the scaled multiplicand; and
outputting a corrected result.

21. The method of claim 20, wherein the corrected result is output through a single architectural rounding path without an intermediate architectural rounding step between in-pipeline scaling of the selected multiplicand and fused multiply-add completion.

22. The method of claim 20, wherein the corrected fused multiply-add operation is executed with zero additional clock cycles relative to a corresponding unscaled fused multiply-add operation.

23. The method of claim 20, further comprising performing cross-device reproducibility verification by comparing outputs or hashes of outputs generated by execution of the corrected fused multiply-add operation on multiple devices.

24. A non-transitory computer-readable medium storing instructions that, when processed in a suitable software and hardware environment, invoke a corrected fused multiply-add operation in an integrated circuit,
wherein the integrated circuit includes:
a fused multiply-add execution pipeline;
a protected internal factor source configured to provide a scaling factor for arithmetic execution;
control logic configured to invoke the corrected fused multiply-add operation;
an in-pipeline scaling stage configured to apply the scaling factor to a selected multiplicand within the fused multiply-add execution pipeline; and
a fused multiply-add core configured to generate a corrected result using the scaled multiplicand.

25. The non-transitory computer-readable medium of claim 24, wherein the instructions are generated by a compiler, backend, assembler, runtime, or code-generation system in response to a source-level intrinsic, built-in, library call, or arithmetic pattern associated with corrected fused multiply-add execution.

26. The method of claim 20, wherein the corrected fused multiply-add operation is used for selected operations in a density-functional-theory exchange-correlation kernel.
